(19) United States
(12) Patent Application Publication
(10) Pub. No.: US 2026/0247124 A1
(43) Pub. Date: Aug. 20, 2026

(54) NON-TERRESTRIAL NETWORK RADIO ACCESS NETWORK ALERT SYSTEM AND METHOD

(71) Applicant: Boost SubscriberCo L.L.C., Englewood, CO (US)

(72) Inventors: Mehdi ALASTI, Arlington, VA (US); Robert GRIMALDI, Parker, CO (US); Grant GENDRON, Washington, DC (US)

(73) Assignee: Boost SubscriberCo L.L.C., Englewood, CO (US)

(21) Appl. No.: 19/058,041

(22) Filed: Feb. 20, 2025

(51) Int. Cl. H04W 4/90; H04W 4/12; H04W 84/06

(52) U.S. Cl. CPC H04W 4/90; H04W 4/12; H04W 84/06

(57) ABSTRACT

A method and system for delivering an alert to an alert zone by logging User Equipment (UEs) that receive 3rd Generation Partnership Project (3GPP) communication from a Non-Terrestrial Network (NTN) Radio Access Network (RAN) is disclosed. The method can include selecting relevant UEs when their geolocation is within the alert zone and transmitting the alert to these UEs via the NTN RAN. The coverage area of the NTN RAN may include the alert zone and a substantial area beyond it, with the alert being relayed by one or more NTN satellites.

### FIELD

The present disclosure relates to a Non-Terrestrial Network (NTN) Radio Access Network (RAN) alert system, and more particularly, to a system and method for providing 3GPP alerts via satellite communication to remote and underserved areas within an alert zone or geographically relevant area. The alerts may be a Wireless Emergency Alert (WEA) and/or a Commercial Mobile Alert System (CMAS) alert.

### BACKGROUND

In recent years, the expansion of wireless communication technologies has significantly enhanced the ability to provide telecommunication services across diverse geographical regions. However, delivering timely and accurate emergency alerts to remote and underserved areas remains a challenge. Traditional terrestrial networks often struggle to provide comprehensive coverage in these regions, leading to a reliance on Non-Terrestrial Networks (NTN) such as satellite communications. Satellites, including Low-Earth Orbit (LEO), Middle-Earth Orbit (MEO), and Geosynchronous-Earth Orbit (GEO) satellites, offer extensive coverage that can span multiple states or countries, making them ideal for reaching areas that are otherwise difficult to serve.

Despite the broad coverage capabilities of NTNs, the delivery of emergency alerts, such as the Commercial Mobile Alert System (CMAS), poses unique challenges. The expansive beam coverage areas of satellites can result in alerts being received by devices far outside the intended alert zones, leading to confusion and potential desensitization to alerts. This issue is compounded by the fact that either the user equipment (UE) operating under certain 3GPP releases is not aware of its mapped cell-ID or that the RAN is not knowledgeable of the UEs location, resulting in the reception of alerts not relevant to the UE's location. As the demand for precise and reliable alert systems grows, there is a pressing need for solutions that can accurately target alerts to specific geographical areas, ensuring that only those in the relevant regions receive the necessary information.

This is particularly complex in the context of Non-Terrestrial Networks (NTNs), which utilize satellite communication to cover vast geographical areas that may be substantially larger than the alert zone. NTNs rely on satellites to broadcast signals over large expanses via beams, which can inadvertently lead to the dissemination of alerts to devices outside the alert zone. A beam coverage area of an NTN may substantially exceed the alert zone. At times, the beam coverage area may be many times greater than the alert zone, for example, two or more, five or more, ten or more, or 50 or more times greater. When the beam coverage area is larger than the alert zone, the alert may alarm users of UE that need not be alerted.

In TNs, a cell coverage area is not a substantial area. For example, for low frequency bands (generally considered to be frequencies below 2.5 GHz), a TN gNB may reach UE up to 10 miles from the gNB (more specifically an antenna the gNB) in rural areas. A cell radius of 10 miles for the 2.5 GHz band typically applies to rural areas. Additionally, low-band frequencies are generally considered to be those below 2.5 GHz. At frequencies higher than 2.5 GHz, cell coverage areas for TNs are even smaller. For suburban deployments, n71 band (600 MHz) may be used with an estimated cell radius of approximately 4.5 km. Due to the small cellular coverage areas of each cell, if an alerted UE is outside the alert zone of alert message, not many untargeted UEs are unnecessarily alerted. However, this approach is untenable for an NTN cell as the cell coverage area of an NTN gNB maybe substantially larger than the alert zone.

The present teachings limit alerting UE outside an alert zone when the cell coverage area encompasses regions other than the alert zone. In the prior art, neither 3GPP TS 23.041 nor ETSI TS 123 041 address CMAS implementation for an NTN, especially when a cell coverage area encompasses a great area beyond the alert zone, leaving this critical issue without standardized solutions.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The method includes delivering an alert to an alert zone by logging User Equipment (UEs) that receive 3rd Generation Partnership Project (3GPP) communication from a Non-Terrestrial Network (NTN) Radio Access Network (RAN). The method can include selecting relevant UEs when their geolocation is within the alert zone and transmitting the alert to these UEs via the NTN RAN. The coverage area of the NTN RAN may include the alert zone and a substantial area beyond it, with the alert being relayed by one or more NTN satellites.

The coverage area can be assigned a cell-id in a RAN, equating it to a cell coverage in the RAN.

Some examples of the NTN satellites may include Low-Earth Orbit (LEO), Middle-Earth Orbit (MEO), or Geosynchronous-Earth Orbit (GEO) satellites, with the substantial area being larger than the alert zone.

The coverage area, alert zone, and substantial area may be polygons of any shape.

The coverage area can be divided into sub-regions, with each sub-region associated with a respective mapped cell-id.

The alert may be delivered by a Wireless Emergency Alert (WEA) compliant system or a Commercial Mobile Alert System (CMAS).

The transmitting can involve sending a unicast message to each of the relevant UEs.

The transmitting may also involve sending a multicast message addressing each of the relevant UEs.

The alert can include a text message specifying the alert zone to which it pertains.

The alert zone may be substantially smaller than a coverage area of a cell of the NTN RAN.

The selecting can involve being informed of a respective Mapped Cell-ID for the relevant UEs complying with a 3GPP NTN Specification (Release 17 and beyond), and including Mapped Cell-IDs relevant to the alert zone in a System Information Block 8 (SIB8) carrying the alert per a 3GPP gNB/RAN Specification.

The method may further involve checking, by some of the complying relevant UEs, the respective Mapped Cell-IDs, and ignoring the alert when the respective Mapped Cell-ID is not present in the Mapped Cell-IDs.

The method can also include configuring the UEs to periodically request a SIB8 on an on-demand basis, with the transmitting involving delivering the alert to one of the UEs through the SIB8 when it is in the alert zone.

The alert may comprise a message content, an alert notification, and the alert zone.

The method can further involve activating the alert at the relevant UEs.

The activating may be performed by some of the relevant UEs in a CONNECTED mode, an IDLE mode, and an INACTIVE mode.

The system may involve delivering an alert to an alert zone, comprising a Non-Terrestrial Network (NTN) Radio Access Network (RAN) configured to provide 3rd Generation Partnership Project (3GPP) communication to User Equipment (UEs) in a coverage area, which includes the alert zone and a substantial area beyond it. The system can include one or more NTN satellites configured to relay the alert and a processor configured to log the UEs receiving the 3GPP communication from the NTN RAN, select relevant UEs when their geolocation is within the alert zone, and transmit the alert to these UEs via the NTN RAN.

Some examples of the NTN satellites may include Low-Earth Orbit (LEO), Middle-Earth Orbit (MEO), or Geosynchronous-Earth Orbit (GEO) satellites, with the substantial area being larger than the alert zone.

To select the relevant UEs, the processor can be configured to be informed of a respective Mapped Cell-ID for the relevant UEs complying with a 3GPP NTN Specification (Release 17 and beyond), and to include Mapped Cell-IDs relevant to the alert zone in a System Information Block 8 (SIB8) carrying the alert per a 3GPP gNB/RAN Specification.

The relevant UEs may be configured to activate the alert.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1A illustrates a WEA/CMAS system 100 to deliver an alert using an NTN, according to various embodiments.

FIG. 1B illustrates a RAN utilizing an NTN including a satellite to provide 3GPP alerts according to various embodiments.

FIG. 2 is a flowchart of an example method for delivering an alert to an alert zone, according to various embodiments.

FIG. 3 illustrates a block diagram of a 5G cellular network system according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

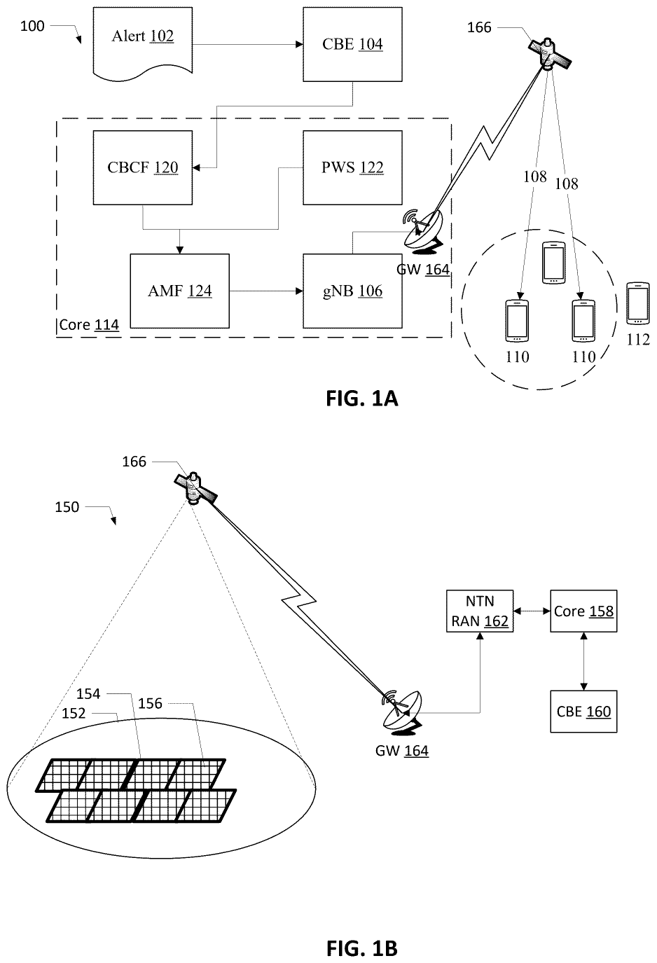

FIG. 1A illustrates an NTN alert system 100 to deliver an alert according to various embodiments.

An NTN alert system 100 may be implemented to work within the 3GPP framework to deliver a CMAS alert using an NTN. An alert delivery is initiated by an alert 102 (such as a CMAS alert) being sent by a Cell Broadcasting Entity (CBE) 104. Alert 102 may include an alert zone and a message. CBE 104 is an authority such as a national authority, a province or state authority, a police or sheriff authority or the like. The CBE 104 may generate messages for public safety, crime prevention or the like. CBE 104 communicates alert 102 to a Cell Broadcast Center Function (CBCF) 120 and the Public Warning System (PWS) 122 via the N50 interface, ensuring that the alert is processed through the appropriate channels. The Access and Mobility Management Function (AMF) 124 further processes the message through the N50/SBc interface, which is for managing the mobility and access aspects of the network. Finally, the Next Generation Node B (gNB) 106 broadcasts the CMAS Alert to devices 110 via the N2 interface, ensuring that the alert reaches the intended geographical area defined by the alert zone. Core 114 may include, among other things, one or more of a CBCF 120, a Public Warning System (PWS), an AMF 122, a satellite gateway 164, an NTN satellite 166 or the like. Only NTN gNBs whose cell coverage area is part of the alert zone in the alert 102 are targeted to broadcast a message of alert 102. The broadcasts, from the target NTN gNBs, warn all User Equipment (UE) 108 in the alert zone of the alert 102; if the cell coverage area covers areas outside the alert zone, UEs located outside the alert zone should disregard the alert, ensuring that only those in the relevant geographical region respond to the alert delivered by the NTN alert system 100. In some embodiments, when the standards catchup, SIB8 alerts may be used to send the alerts.

The components in the flowchart are interconnected to facilitate the seamless transmission of alerts. The CBE, CBCF, and PWS are depicted as distinct entities that collaborate to handle the initial stages of the alert process. The AMF acts as a central processing unit that manages the flow of information between these entities and the gNB. The gNB is responsible for the final broadcast of the alert to user equipment (UE) within the alert zone. In some embodiments, the broadcast is achieved through the N2 interface, which is a link in ensuring that the alert is disseminated effectively.

The CBE initiates the alert, while the CBCF and PWS ensure that the message is correctly formatted and routed. The AMF processes the message, taking into account the mobility and access requirements of the network. The gNB then broadcasts the alert, ensuring that only UEs within the specified alert zone respond. This leverages the NTN's capabilities to cover extensive areas, ensuring that alerts are delivered efficiently and accurately to the relevant UEs. In some embodiments, use of SIB8 in the broadcast process highlights the system's compliance with 3GPP standards, ensuring that the alert is compatible with existing network infrastructure.

FIG. 1B illustrates an NTN RAN alert system including a satellite to provide 3GPP alerts according to various embodiments.

An NTN RAN alert system 150 includes a satellite 166 communicating with a gateway 164. Satellite 166 may be Low-Earth Orbit (LEO), Middle-Earth Orbit (MEO) and Geosynchronous-Earth Orbit (GEO) satellite that provides coverage in remote and underserved areas. The gateway 164 may be connected to NTN RAN 162 including a core 158. The core 158 may receive an alert (not shown) from a CBE 160.

Satellite 166 may provide communication services to a beam coverage area 152. Beam coverage area is significantly large, potentially spanning across multiple states or even countries. As such, an alert intended for a county could inadvertently reach devices across several counties or even states. Beam coverage area 152 may cover a plurality of alert zones 154. Beam coverage area 152 may be a polygon of any shape. Beam coverage area 152 may be assigned a cell-id in NTN RAN 162. In other words, in an NTN proving 3GPP alert services, the beam coverage area 152 may be synonymous with a coverage area for the cell-id (and the associated gNB) in NTN RAN 162.

As an NTN cell-id is mapped to an expansive coverage area, the NTN cell-id may be mapped to mapped cell-ids. Each mapped cell-id is associated with a sub-area 156 of the cell or beam coverage area in an NTN RAN. Sub-areas 156 may be a polygon of any shape. Each alert zone 154 may cover a plurality of sub-areas. Alert zone 154 may be a polygon of any shape. NTN RAN 162 connects to UEs (not shown) capable of receiving 3GPP alerts, which UEs are disposed in beam coverage area 152. Cells 156 may be a polygon of any shape.

### Alert All UE in NTN Coverage

This embodiment maybe used on a permanent basis or until a better, more accurate solution is designed and implemented. In this embodiment, CBE transmits a CMAS alert for distribution to an alert zone reachable via NTN beam. The alert is broadcast to all UE within the coverage of the NTN beam. The message within the alert specifies the geographical area or alert zone to which the CMAS alert pertains. UEs located outside the alert zone should disregard the alert, ensuring that only those in the relevant geographical region respond accordingly.

### Alert UE in Mapped Cell-IDs That Overlap Alert Zone

The NTN determines or receives locations of UE accessible via an NTN beam. The NTN provides the locations of UE accessible to the RAN or core. The locations of UEs accessible via NTN beam are mapped to Mapped Cell-IDs based on geographical areas of respective Mapped Cell-IDS configured in RAN and Core. In some embodiments, a specific geographical location may be mapped to multiple Mapped Cell IDs, e.g., overlapping coverage for geolocations. In some embodiments, a gNB constructs a list of Mapped Cell-IDs targeting an alert zone based on UE geolocations of UE accessible via NTN beam.

In the prior art, a UE may not know its mapped cell-ID. UE operating under 3GPP Releases 17, 18, and 19 do not know their respected mapped cell-ID. As a result, these UEs still receive alerts for regions outside an alert's intended alert zone. However, UEs complying with 3GPP specification release beyond Release 19 (for example, Release 20 and beyond) are expected to be informed of their associated Mapped Cell-IDs. A specification Release beyond Release 19 for an AMF may enable inclusion of a list of all relevant Mapped Cell-IDs in the SIB8 carrying CMAS alert message. Any compliant UEs accessible for these future specifications alerted via an NTN beam may check the SIB8 mapped cell-ID list, and if their Mapped Cell-ID is not present, they ignore the alert.

### Alert UE in Alert Zone Via Broadcast

In 5G NR, system information blocks (SIBs) like SIB2, SIB3, . . . , SIB8, and SIB9 can be broadcast by the RAN to ensure wide and immediate distribution to all connected UEs. A 3GGP alert may be broadcast using SIBs.

### Alert UE in Alert Zone Via Device Request

A UE connected to a RAN via an NTN may periodically request SIB8 (CMAS) from the network. The request may include the UE's geolocation, or the UE's geolocation may have calculated, inferred or previously provided. When the UE is in an alert zone, the RAN delivers the CMAS alert through the SIB8 message. This embodiment may be implemented without any standardization efforts.

### Alert UE in Alert Zone Via NTN RAN Push

5G NR allows system information (e.g., SIB8) to be delivered via RRC messaging to UE in CONNECTED Mode. The NTN RAN maintains a list of all UE connected via the NTN, and their respective Mapped Cell-IDs and/or geolocation. For each alert, UE in the alert (determined by either the respective Mapped Cell-IDs or geolocation), the NTN RAN delivers the CMAS alert individually via a SIB8 one UE at a time through RRC, for example. In this embodiment, delivery of an alert is not as a broadcast. This embodiment may be implemented without any standardization efforts and is limited to UE connected via the NTN in the alert zone. When the device is in a mode other than CONNECTED, for example, in IDLE or INACTIVE Mode, the NTN RAN may retry later when the UE is placed in CONNECTED mode.

### Alert UE in Alert Zone Via NTN RAN Text Messaging Push

By Tracking UE Locations, an NTN RAN receives the location of every UE being serviced by the NTN RAN. When an alert is sent to an alert zone (such as a specific geographical area), the known locations of the UEs are used to select UEs that are sent a text message including the alert message directly. This ensures the message is delivered to the relevant UEs, whether they are in CONNECTED, INACTIVE, or IDLE mode. As such, each relevant UE receives the alert individually.

The NTN RAN may constantly track each NTN service UE's location. In some embodiments, the alert message may be transmitted via an over-the-top (OTT) communication and does not have to be like SMS or MMS delivery. For TNs, UE location tracking could be coarse (using cell IDs), but in NTN, it a more precise location may be used.

In some embodiments, instead of using unicast delivery of the alert through text messaging or the like, the network could employ 3GPP MBMS (Multimedia Broadcast Multicast Service). To utilize MBMS, the NTN RAN may add all the UEs in the alert zone in a multicast group and send the alert in one shot to all the UEs in that multicast group. As such, the alert may reach all relevant UEs, even if they are in IDLE mode, with a single transmission.

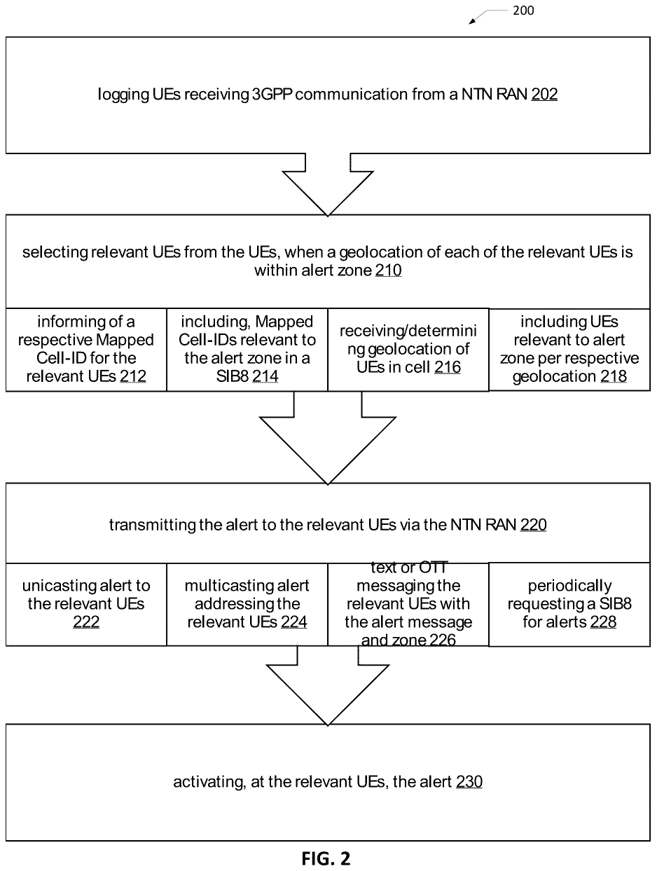

FIG. 2 illustrates a method for delivering an alert to an alert zone according to various embodiments.

A method 200 for delivering an alert to an alert zone may include an operation 202 for logging UEs receiving 3GPP communication from an NTN RAN. Method 200 may include operation 210 for selecting relevant UEs from the UEs in a cell, when a geolocation of each of the relevant UEs is within alert zone.

In some embodiments, operation 210 may include operation 212 for informing of a respective Mapped Cell-ID for the relevant UEs 212. Operation 210 may include operation 214 for including, Mapped Cell-IDs relevant to the alert zone in a SIB8.

In some embodiments, operation 210 may include operation 216 for receiving/determining geolocation of UEs in cell. In one embodiment, operation 216 may be performed during the logging (operation 202). Operation 210 may include operation 218 for including UEs relevant to alert zone per respective geolocation.

Method 200 may include operation 220 for transmitting the alert to the relevant UEs via the NTN RAN. Operation 220 may include operation 222 for unicasting the alert to the relevant UEs. In some embodiments, operation 220 may include operation 224 for multicasting the alert addressing the relevant UEs. In some embodiments, operation 220 may include operation 226 for text or OTT messaging the relevant UEs with the alert message and zone. In some embodiments, operation 220 may include operation 228 for periodically requesting a SIB8 for alerts.

In some embodiments, method 200 may include operation 230 for activating, at the relevant UEs, the alert.

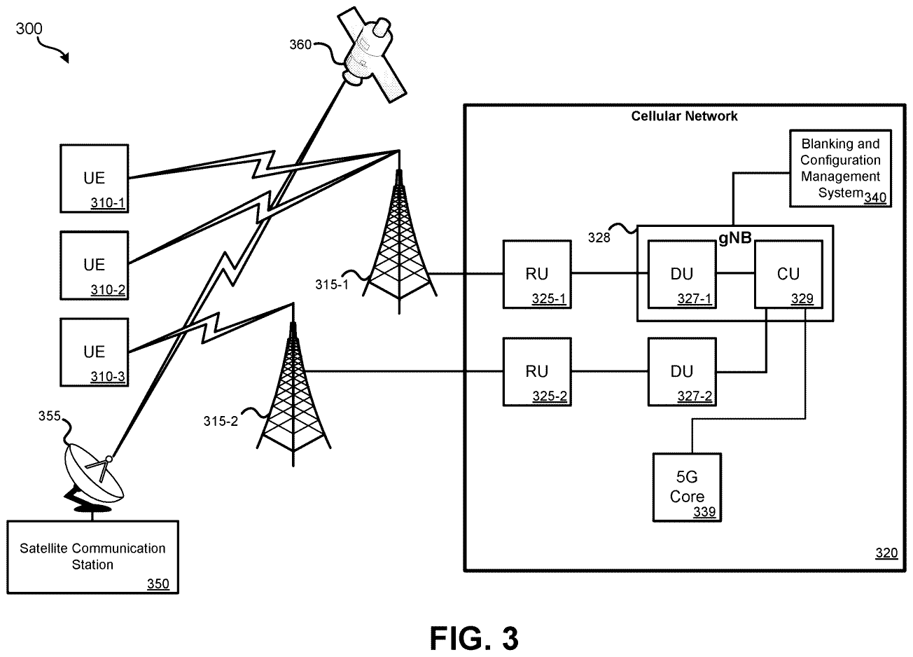

FIG. 3 illustrates a block diagram of an embodiment of a 5G cellular network system (“system 300”). System 300 can include a 5G New Radio (NR) cellular network or other types of cellular networks that permit slicing are also possible (e.g., future 6G and beyond cellular networks). System 300 can include: UE 310 (UE 310-1, UE 310-2, UE 310-3); base station 315; cellular network 320; radio units 325 (“RUs 325”); distributed units 327 (“DUs 327”); centralized unit 329 (“CU 329”); 5G core 339, and blanking and configuration management system 340 (“system 340”). FIG. 3 represents a component level view. In an open radio access network (O-RAN) using virtualization, components can be implemented as software, such as on a cloud-computing platform, except for components that need to receive and transmit RF. Therefore, the functionality of the various components can be shifted among different servers and/or data centers to accommodate where the functionality of such components is needed and/or where processing, storage, and/or bandwidth is available.

UE 310 can represent various types of end-user devices, such as smartphones, cellular modems, cellular-enabled computerized devices, sensor devices, gaming devices, access points (APs), any computerized device capable of communicating via a cellular network, etc. UE 310 may use RF to communicate with various BSs of cellular network 320. As illustrated, two base stations 315 (BS 315-1, 315-2) are illustrated. Real-world implementations of system 300 can include many (e.g., thousands) of base stations, RUs, DUs, and CUs. BS 315 can include one or more antennas that allow RUs 325 to communicate wirelessly with UE 310. RUs 325 can represent an edge of cellular network 320 where data is transitioned to wireless communication. The radio access technology (RAT) used by RU 325 may be 5G New Radio (NR), or some other RAT. The remainder of cellular network 320 may be based on an exclusive 5G architecture, a hybrid 4G/5G architecture, a 4G architecture, or some other cellular network architecture. Base station equipment may include an RU (e.g., RU 325-1) and a DU (e.g., DU 327-1). An RU and a DU can be co-located at a BS or a DU can be remote from the BS.

One or more RUs, such as RU 325-1, may communicate with DU 327-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of spectrum, such as, for example, band n71. One or more DUs, such as DU 327-1, may communicate with CU 329. Collectively, RUs, DUs, and CUs serve as the radio access network (RAN) of cellular network 320. CU 329 can communicate with 5G core 339. The specific architecture of cellular network 320 can vary by embodiment.

Multiple slices may function on the underlying hardware detailed in FIG. 3. That is, UE 310-1 and UE 310-2, while communicating with the same base station, may be provided with different QoS/QoE levels of service by virtue of being assigned to different slices. Each slice may be associated with differing performance characteristics. For each slice, many characteristics or parameters may be defined, such as: downlink/uplink throughput (aggregate for network slice); downlink/uplink throughput (per UE); maximum downlink/uplink throughput; maximum supported packet size; mission critical level (e.g., compared to other network slices); radio spectrum; packet error rate; supported access technologies; supported device velocity for a defined QoS; uplink throughput (aggregate for network slice); maximum uplink throughput; and/or synchronicity. Other parameters for a slice may also be defined, such as: a defined latency range for specific end-points; reserved or shared spectrum; one or more particular security profiles; optimization for specific applications or sets of applications (e.g., healthcare applications, industrial applications); optimization for high-speed mobility; and varying degrees of customer-side control of network parameters. Other parameters may also be defined, such as parameters for individual layers within each network slice. Such individual layers may allow for particular types of data or data associated with particular applications to be prioritized over other applications.

Blanking and configuration management system 340 may be one or more computer servers or a process that hosted on a cloud-based computing platform. System 340 may be in communication with components of cellular network 320, such as directly with a DU or CU of a gNodeB (e.g., gNB 328) at which blanking needs to be performed. At a high level, blanking and configuration management system 340 schedules PRB blanking for individual BSs to accommodate reserved frequency bands being used by one or more primary entities. In some embodiments, rather than having a centralized blanking and configuration management system 340, system 340 may be incorporated as part of or in communication with each gNB of the cellular network that needs to occasionally avoid a primary entity's frequency band(s).

Functioning independently of the cellular network can be satellite ground communication station 350, satellite antenna 355, and satellite 360. Satellite ground communication station 350 communicates with satellite 360 via satellite antenna 355 on one or more particular frequency bands. If UE 310 and/or BSs 315 are operating on the same or overlapping subcarriers, interference can result in satellite ground communication station 350 and satellite 360 being unable to communicate or can result in decreased quality of service. Satellite 360 may be in LEO or MEO and communication between satellite ground communication station 350 and satellite 360 may only occur when the orbit of satellite 360 allows for a line-of-sight communication link between satellite antenna 355 and an antenna of satellite 360. Satellite ground communication station 350 may also periodically or occasionally communicate with one or more other satellites, possibly using the same or different frequency bands. In the embodiments detailed herein, the operator of satellite ground communication station 350 and satellite 360 is the primary user of the one or more particular frequency bands. Accordingly, the cellular network operator is required to not interfere with the operations of the satellite operator.

Cellular networks include Radio Access Networks (RANs) and a network core. RANs belonging to 4G are known as Long Term Evolution (LTE) and RANs belonging to 5G are known as New Radio (NR), which has been standardized to allow tight interworking with LTE. The RAN includes antennae seen on cellular telecommunications towers and other locations (e.g., on top of buildings, in stadiums, etc.). When a cellular telephone call is made via a mobile device or a Short Message Service (SMS) message is sent, for example, antenna(s) of the RAN transmits signals to and receive signals from the mobile device. The RAN base station also digitizes the signals from the mobile device and sends this information to the network core.

In an Open RAN (O-RAN) architecture, the RAN includes three main building blocks: the Radio Unit (RU), the Distributed Unit (DU), and the Centralized Unit (CU). The RUs transmit, receive, amplify, and digitize radio frequency signals. RUs are located near, or integrated into, an antenna of the cellular telecommunications tower, and are operably connected to the antenna. Each cellular telecommunications tower may have multiple RUs to fully service various bands for a particular coverage area. The DU receives the digitized radio signals from the RU(s) via a Cellular Site Router (CSR) that routes traffic from the RUs to the DU and sends the digitized radio signal to the CU for further processing. The DU is usually physically located at or near the RU, whereas the CU can be located nearer to the network core (e.g., in a Pass-through Edge Data Center (PEDC) or a Breakout Edge Data Center (BEDC)).

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, mid-haul between the DU and the CU, and backhaul connecting the RAN to the network core. The CU accommodates the higher protocol stack layers while the DU accommodates the lower protocol stack layers.

DUs are the main processing units that are responsible for the High Physical, Media Access Control (MAC), and Radio Link Control (RLC) protocols in the RAN protocol stack under the Third Generation Partnership Project (3GPP). In other words, DUs are a logical encapsulation of the 3GPP stack. In O-RAN or virtualized RAN (vRAN), DUs typically run the real time RAN functions located below split 2 and connect with the RUs through a fronthaul interface based on O-RAN split 7-2x. DUs perform Layer 1 (L1) and Layer 2 (L2) processing.

Kubernetes® may be used for DUs to provide a portable, extensible, open-source platform for managing containerized workloads and services that facilitates both declarative configuration and automation. Containers are similar to Virtual Machines (VMs). However, they have relaxed isolation properties to share the Operating System (OS) among the applications. Therefore, containers are considered lightweight. Similar to a VM, a container has its own file system, a share of Central Processing Unit (CPU) resources, memory, process space, etc. Since containers are decoupled from the underlying infrastructure, they are portable across clouds and OS distributions. DUs may be responsible for performing PRB blanking.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for delivering an alert to in an alert zone, the method comprising:
logging User Equipment (UEs) receiving 3rd Generation Partnership Project (3GPP) communication from a Non-Terrestrial Network (NTN) Radio Access Network (RAN);
selecting relevant UEs from the UEs, when a geolocation of each of the relevant UEs is within the alert zone; and
transmitting the alert to the relevant UEs via the NTN RAN,
wherein the coverage area of the NTN RAN comprises the alert zone and a substantial area beyond the alert zone, and the alert is relayed by one or more NTN satellites.

2. The method of claim 1, wherein the coverage area is assigned a cell-id in a RAN and the coverage area is equated to a cell coverage in the RAN.

3. The method of claim 1, wherein the one or more NTN satellites is selected from one of a Low-Earth Orbit (LEO) satellite, a Middle-Earth Orbit (MEO) satellite, or a Geosynchronous-Earth Orbit (GEO) satellite, and wherein the substantial area is greater in size than the alert zone.

4. The method of claim 1, wherein the coverage area, the alert zone, and the substantial area are polygons of any shape.

5. The method of claim 1, wherein the coverage area is divided into sub-regions and each of the sub-regions is associated with a respective mapped cell-id.

6. The method of claim 1, wherein the alert is delivered by a Wireless Emergency Alert (WEA) compliant system or a Commercial Mobile Alert System (CMAS).

7. The method of claim 1, wherein the transmitting comprises a unicast message sent to each of the relevant UEs.

8. The method of claim 1, wherein the transmitting comprises a multicast message addressing each of the relevant UEs.

9. The method of claim 1, wherein the alert comprises a text message specifying the alert zone to which the alert pertains.

10. The method of claim 1, wherein the alert zone is substantially smaller than a coverage area of a cell of the NTN RAN.

11. The method of claim 1, wherein the selecting comprises being informed of a respective Mapped Cell-ID for the relevant UEs complying with a 3GPP NTN Specification, and the selecting further comprises including, Mapped Cell-IDs relevant to the alert zone in a System Information Block 8 (SIB8) carrying the alert per a 3GPP gNB/RAN Specification.

12. The method of claim 11, further comprising checking, by one or more of the complying relevant UEs, the respective Mapped Cell-IDs, and ignoring the alert when the respective Mapped Cell-ID is not present in the Mapped Cell-IDs.

13. The method of claim 1, further comprising configuring the UEs to periodically request a SIB8 on an on-demand basis, wherein the transmitting comprises delivering, by the NTN RN, the alert to one of the UEs through the SIB8 when the one of the UEs is in the alert zone.

14. The method of claim 1, wherein the alert comprises a message content, an alert notification, and the alert zone.

15. The method of claim 1, further comprising activating, at the relevant UEs, the alert.

16. The method of claim 15, wherein the activating is performed by one or more the relevant UEs in a CONNECTED mode, an IDLE mode, and an INACTIVE mode.

17. A system for delivering an alert to an alert zone, the system comprising:
a Non-Terrestrial Network (NTN) Radio Access Network (RAN) configured to provide 3rd Generation Partnership Project (3GPP) communication to User Equipment (UEs) in a coverage area, wherein the coverage area comprises the alert zone and a substantial area beyond the alert zone;
one or more NTN satellites configured to relay the alert; and
a processor configured to:
log the UEs receiving the 3GPP communication from the NTN RAN,
select relevant UEs from the UEs, when a geolocation of each of the relevant UEs is within the alert zone, and
transmit the alert to the relevant UEs via the NTN RAN.

18. The system of claim 17, wherein the one or more NTN satellites is selected from one of a Low-Earth Orbit (LEO) satellite, a Middle-Earth Orbit (MEO) satellite, or a Geosynchronous-Earth Orbit (GEO) satellite, and wherein the substantial area is greater in size than the alert zone.

19. The system of claim 17, wherein to select the relevant UEs, the processor is configured to be informed of a respective Mapped Cell-ID for the relevant UEs complying with a 3GPP NTN Specification, and to include Mapped Cell-IDs relevant to the alert zone in a System Information Block 8 (SIB8) carrying the alert per a 3GPP gNB/RAN Specification.

20. The system of claim 17, wherein the relevant UEs are configured to activate the alert.
